(19) United States
(12) Patent Application Publication
(10) Pub. No.: US 2005/0020392 A1
(43) Pub. Date: Jan. 27, 2005

(54) Composite sprocket

(76) Inventor: John D. Redmond, Littleton, CO (US)

Correspondence Address: Jeffrey Thurnau;The Gates Corporation, IP Law Dept. 10-A3, Denver, CO, 80202, US

(21) Appl. No.: 10/894,662

(22) Filed: Jul. 20, 2004

Related U.S. Application Data
(60) Provisional application No. 60/489,407, filed on Jul. 22, 2003.

(51) Int. Cl. F16H 7/14

(52) U.S. Cl. 474/116

(57) ABSTRACT

A composite sprocket. The sprocket comprises a polymer outer ring mounted to a metallic inner hub. The outer ring has a profile, for example, a toothed profile. The toothed ring comprises a thermoset material such as polyurethane. The hub comprises any suitable metallic or non-metallic material sufficient for transmitting a torque from the ring to a shaft. A retaining ring or adhesives or both are used to lock the ring in place on the hub. Cooperating transverse lugs on the ring and grooves in the hub prevent the ring from rotating when subjected to a torque. A retaining member or members are used to prevent lateral movement of the ring.

### FIELD OF THE INVENTION

The invention relates to a sprocket and more particularly to a composite sprocket comprising a polymer ring mounted to a metallic hub with retaining members and a transverse lug.

### BACKGROUND OF THE INVENTION

Sprockets are well known in the art of power transmission. Two or more sprockets may be connected by a belt, chain or other flexible member suitable for bearing a tensile load. A sprocket may have a flat belt bearing surface or comprise transversely mounted teeth, gears or grooves.

Prior art sprockets are generally homogeneous, meaning the body of the sprocket and the teeth are made or cut out of the same material. The material may comprise metal, plastic, or other suitably tough material. In other instances the sprocket teeth are removable. This allows the teeth to be individually replaced, allowing the sprocket to remain in service during maintenance. The prior art sprockets of this type comprise metal such as steel and are used in severe duty applications such as on earth moving equipment.

Representative of the art is U.S. Pat. No. 4,752,281 (1988) to Lammers which discloses a drive sprocket assembly having a support hub and a plurality of replaceable teeth.

Also representative of the art is GB 2064708 (1980) to Berg which discloses a composite gear or sprocket wheel, the outer toothed portion is formed of a piece of continuously moulded flexible gear belting attached to the rim of the gear or sprocket wheel center blank or disc.

Reference is also made to copending application Ser. No. 10/404,181 filed Mar. 31, 2003 by the same inventor as the instant invention which discloses a composite sprocket having a non-metallic ring for engaging a driving member.

The prior art sprockets do not teach a hub having a removable wear surface attached to the hub using a retaining ring and transverse lugs to prevent rotation.

What is needed is a composite sprocket having a hub with a removable wear surface attached to the hub by retaining members and having transverse lugs to prevent rotation between the hub and the removable wear surface. The present invention meets this need.

### SUMMARY OF THE INVENTION

The primary aspect of the present invention is to provide a composite sprocket having a hub with a removable wear surface attached to the hub by retaining members and having transverse lugs to prevent rotation between the hub and the removable wear surface.

Other aspects of the invention will be pointed out or made apparent by the following description of the invention and the accompanying drawings.

The invention comprises a composite sprocket. The sprocket comprises a polymer outer ring mounted to a metallic inner hub. The outer ring has a profile, for example, a toothed profile. The toothed ring comprises a thermoset material such as polyurethane. The hub comprises any suitable metallic or non-metallic material sufficient for transmitting a torque from the ring to a shaft. A retaining ring or adhesives or both are used to lock the ring in place on the hub. Cooperating transverse lugs on the ring and grooves in the hub prevent the ring from rotating when subjected to a torque. A retaining member or members are used to prevent lateral movement of the ring.

### BRIEF DESCRIPTION OF THE DRAWINGS

FIG. 1 is a cross-sectional view of the inventive sprocket.

FIG. 2 is a partial plan view of the inventive sprocket at A-A in FIG. 1.

FIG. 3 is a cross-sectional view of an alternate embodiment.

FIG. 4 is a cross-sectional view of an alternate embodiment.

FIG. 5 is a cross-sectional view of an alternate embodiment.

FIG. 6 is a cross-sectional view of an alternate embodiment.

FIG. 7 is a cross-sectional view of an alternate embodiment.

FIG. 8 is a cross-sectional view of an alternate embodiment.

FIG. 9 is a cross-sectional view of an alternate embodiment.

FIG. 10 is a side view of the inventive sprocket in a motorcycle secondary drive and suspension.

Description of the Preferred Embodiment of the Invention

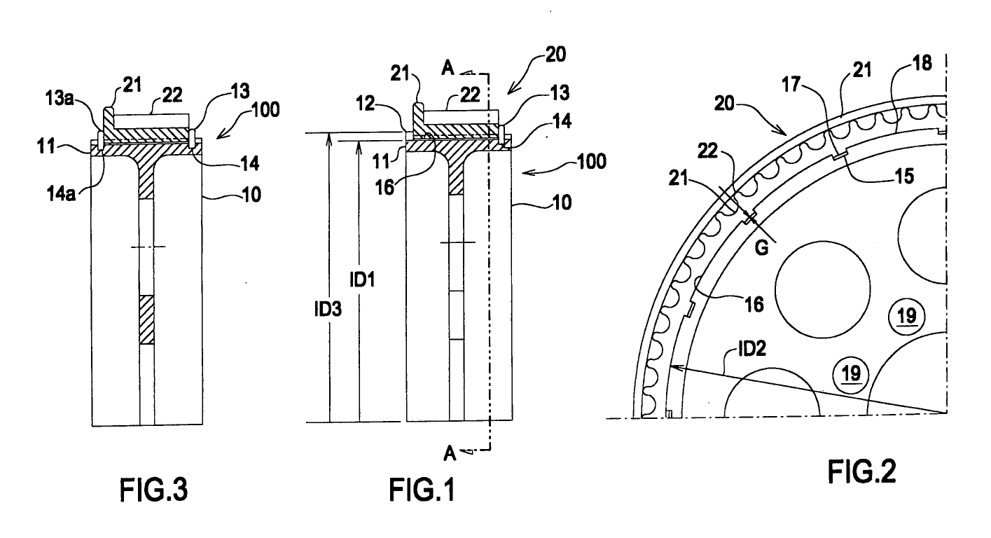

FIG. 1 is a cross-sectional view of the inventive sprocket. Composite sprocket 100 generally comprises hub 10 and ring 20.

Hub 10 has an outer rim 11. Outer rim 11 comprises radial projection or shoulder 12. Hub 10 may comprise any suitable material for transmitting a torque such as metallic or non-metallic material, for example but not by way of limitation steel, stainless steel with hardening on the belt bearing surface, aluminum, as well as their equivalents, or a combination thereof.

Circular member or ring 20 comprises a flange 21 disposed on one side of the ring for keeping a belt trained thereon. Ring 20 also comprises an outer profile, for example, a toothed profile for engaging a belt comprising grooves 21 between teeth 22, see FIG. 2. A toothed belt, also referred to as a synchronous belt, is used in motorcycles drives. Ring 20 may also comprise a flat or grooved profile as well.

Ring 20 comprises a polymeric material, namely, molded thermoset or thermoplastic including but not limited to polyurethane, polyamide, polystyrene, polyethylene, and a combination of two or more of the foregoing, and their equivalents. For example, ring 20 may comprise Adiprene L-325, which is a liquid urethane elastomer that can be cured to a strong, rubbery solid by reaction of its terminal isocyanate groups with polyamine or polyol compounds. Properly cured L-325 yields hard tough products that approach the strength of structural plastics. L-325 typically has high impact strength and resistance to abrasion and deformation with resilience and extensibility. L-325 vulcanizite is resistant to heat, water, ozone, oils and most solvents.

Use of a thermoset or thermoplastic material has the advantage of improving resistance to the effects of debris caught between a belt and ring 20. The ring is more compliant than prior art metal sprockets allowing the ring to partially absorb part of a debris penetrating force which otherwise would be absorbed solely by a belt, thereby facilitating a belt failure. Ring 20 may also comprise a metallic material.

Ring 20 is molded having a radius ID1 under ambient conditions. An outer surface 16 of outer rim 11 is fabricated with a radius ID2. Shoulder 12 has a radius ID3. Radius ID3 is greater than ID1. The relationship between ID1, ID2 and ID3 is a function of the coefficient of thermal expansion of the ring 20. It is desirable that the ring be expandable just enough so that after it is heated it can be slipped or pressed onto rim 11 to bear upon surface 16. Upon cooling the ring shrinks back to ID1.

Retaining member or retaining ring 13 is engaged with circumferential groove 14 in rim 11. Retaining ring 13 prevents lateral movement and retains ring 20 on outer surface 16. By way of example and not of limitation, a retaining ring manufactured by Smalley Steel Ring Company, part number WS-1100 may be used in the invention.

To assemble the composite sprocket, ring 20 is heated as necessary in order to slightly soften and expand the ring. The temperature range to which the ring is heated is approximately 65° C. to 175° C. Heating the ring expands the radius ID1 according to the coefficient of thermal expansion of the ring material. Ring 20 is then pressed over and engaged with surface 16. Lugs 17 are aligned with and engage grooves 15. Hub 10 is maintained at an ambient temperature, approximately 23° C., during this process. As ring 20 cools it shrinks, returning the ring to ID1, thereby mechanically locking ring 20 into hub 10. Retaining ring 13 is then snapped in place in groove 14.

In another embodiment, no retaining ring is used. Ring 20 is retained by the radial dimensional difference between ID1 and ID3. Namely ID3 is of a sufficient magnitude to prevent ring 20 from coming off the sprocket once it cools by creating an interference fit between the ring and the hub.

A metallic ring may also be installed in a like manner, that is by heating to partially expand the ring and then sliding it on the hub while the hub is maintained at an ambient temperature. Retaining ring 13 is used to hold metallic ring 20 in place. The metallic embodiment may comprise stainless steel with a hardened belt bearing surface. Bolts (not shown) are engaged through holes 19 to attach hub 10 to a known motorcycle wheel W.

FIG. 2 is a partial plan view of the inventive sprocket at A-A in FIG. 1. Grooves 21 and teeth 22 can describe any profile known in the sprocket arts.

Ring 20 comprises lugs 17 which extend transversely across a ring width on a ring inner surface 18. Lug receiving grooves 15 are disposed about outer surface 16. Lug grooves 15 are transversely oriented in order to cooperatively engage lugs 17 when ring 20 is pressed onto outer surface 16. Grooves 15 are slightly deeper than a lug height in order to facilitate installation and to eliminate radial interference between the lug and the groove, see gap G. Lugs 17 lock the ring in place on the hub so that an excessive torque does not result in a relative rotational movement of the ring and the hub.

Certain pairs of lugs 17 and grooves 15 may be circumferentially spaced so as to create a particular keyed arrangement whereby a certain orientation may be realized between ring 20 and hub 10. For example, a spacing between two lug and groove set may be less than a spacing between another lug and groove set. This keyed feature can be used to assure a desired relationship between the ring and sprocket.

Surface 16 may be treated with a known adhesive to bind ring 20 to hub 10. For example, any epoxy adhesive suitable for the temperature and materials can be used, including but not limited to the 3M series 800 epoxies such as 3M DP810™. Further, an interference fit may be created by making ID2 greater than ID1 in an ambient temperature condition. Either method of fixing the ring to the hub serves to lock the ring in place on the hub, thereby preventing it from moving relative to the hub while transmitting a torque.

The inventive sprocket facilitates maintenance of the sprocket. Once the toothed profile has worn a predetermined amount, the outer ring 20 can easily be removed and replaced. This eliminates the need to replace the entire sprocket, as well as eliminating the need to remove the entire sprocket from a wheel.

The sprocket, wheel and tire represent a significant part of the unsprung weight of the rear suspension of a motorcycle. Reducing the unsprung weight can significantly improve the handling characteristics of a motorcycle. The inventive sprocket serves such a purpose. Use of a thermoplastic ring 20 significantly reduces a sprocket weight. For example, an average density for high speed tool steel is ˜8.7 gm/cc, or 546 lb/ft³. An average density for polyurethane is ˜1.3 g/cc, or, 82 lb/ft³. This difference in density represents a significant weight reduction in a single composite pulley system, as well as a significant weight reduction in a system utilizing multiple composite pulleys.

Using the inventive sprocket in a typical motorcycle rear suspension this can result in an unsprung weight reduction of approximately 676 grams. For example, a known aluminum sprocket, wheel, brake disc, mounting bolts (5) and tire combination weighs 21.12 kilograms. The same combination using the inventive composite sprocket weighs 20.45 kilograms. More particularly, the known metal sprocket used in the foregoing system weighs 2,832 grams. A composite sprocket of identical physical design weighs 2,147 grams, a sprocket weight reduction of approximately 25%. This also directly affects the suspension components such as the shocks and springs by a reduction in service conditions and thereby overall cost.

FIG. 3 is a cross-sectional view of an alternate embodiment. In this alternate embodiment shoulder 12 is replaced by another retaining ring 13a. This embodiment comprises a retaining ring on each side of ring 20. With this embodiment ring 20 can be installed or removed from rim 11 from either side. It also represents a net weight reduction by replacing metal shoulder 12 with groove 14a and retaining ring 13a.

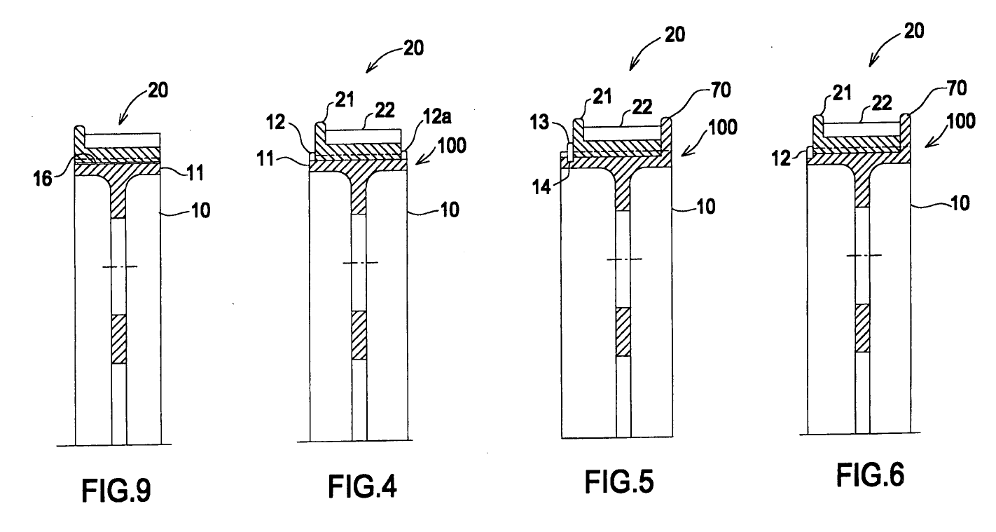

FIG. 4 is a cross-sectional view of an alternate embodiment. In this alternate embodiment retaining ring 13 is replaced by another shoulder 12. This embodiment comprises a shoulder 12 on each side of ring 20. With this embodiment ring 20 can be installed or removed from rim 11 from either side.

FIG. 5 is a cross-sectional view of an alternate embodiment. In this embodiment, flange 70 extends radially from a side of rim 11. A retaining ring 13 is engaged with groove 14. Ring 20 is held between retaining ring 13 and flange 70.

FIG. 6 is a cross-sectional view of an alternate embodiment. In this embodiment, flange 70 extends radially from a side of rim 11. A shoulder is disposed opposite flange 70 on rim 11. Ring 20 is held between shoulder 13 and flange 70. To install, ring 20 is heated to a temperature as disclosed herein. Ring 20 is then pressed over shoulder 12. As ring 20 cools it decreases in radius thereby becoming mechanically constrained between shoulder 12 and flange 70.

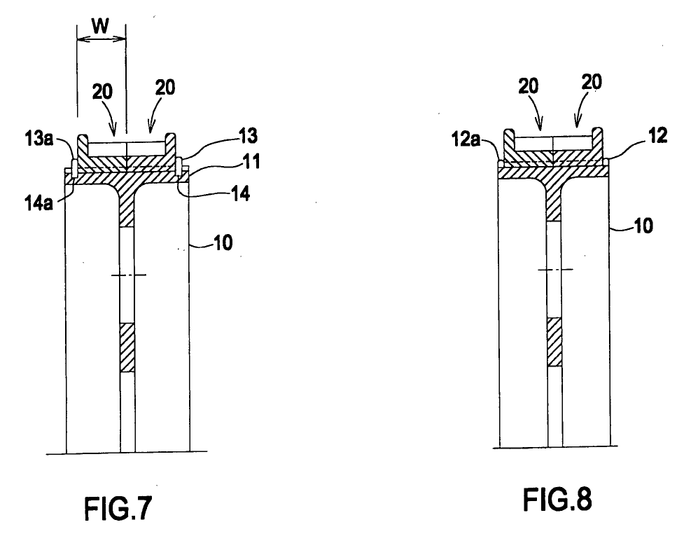

FIG. 7 is a cross-sectional view of an alternate embodiment. The embodiment in FIG. 7 is the same as the embodiment described in FIG. 3, with the exception that this embodiment comprises two rings 20. Rings 20 are each as described in FIG. 2. Each ring 20 has a width (W) that allows two rings 20 to be mounted on rim 11 side-by-side. Lugs 17 and grooves 15 assure proper alignment of the two rings.

FIG. 8 is a cross-sectional view of an alternate embodiment. The embodiment in FIG. 8 is the same as the embodiment described in FIG. 4, with the exception that this embodiment comprises two rings 20. Rings 20 are each as described in FIG. 2. Each ring 20 has a width (W, see FIG. 7) that allows two rings 20 to be mounted on rim 11 side-by-side. Lugs 17 and grooves 15 assure proper alignment of the two rings.

FIG. 9 is a cross-sectional view of an alternate embodiment. In this embodiment no retaining ring or shoulder is sued to retain ring 20 on rim 11. Ring 20 has an inside diameter that is somewhat smaller that an outside diameter of rim 11. Ring 20 is then heated as described elsewhere in this specification. Ring 20 is them pressed on rim 11 and allowed to cool. This creates an interference fit between ring 20 and rim 11. Lugs 17 and grooves 15 are as described in FIG. 2.

Surface 16 may be treated with a known adhesive to further bind ring 20 to hub 10. For example, any epoxy adhesive suitable for the temperature and materials can be used, including but not limited to the 3M series 800 epoxies such as 3M DP810™. Further, an interference fit may be created by making ID2 greater than ID1 in an ambient temperature condition. Either method of fixing the ring to the hub serves to lock the ring in place on the hub, thereby preventing it from moving relative to the hub while transmitting a torque.

In an alternate embodiment ring 20 is cast in place on rim 11 using known techniques.

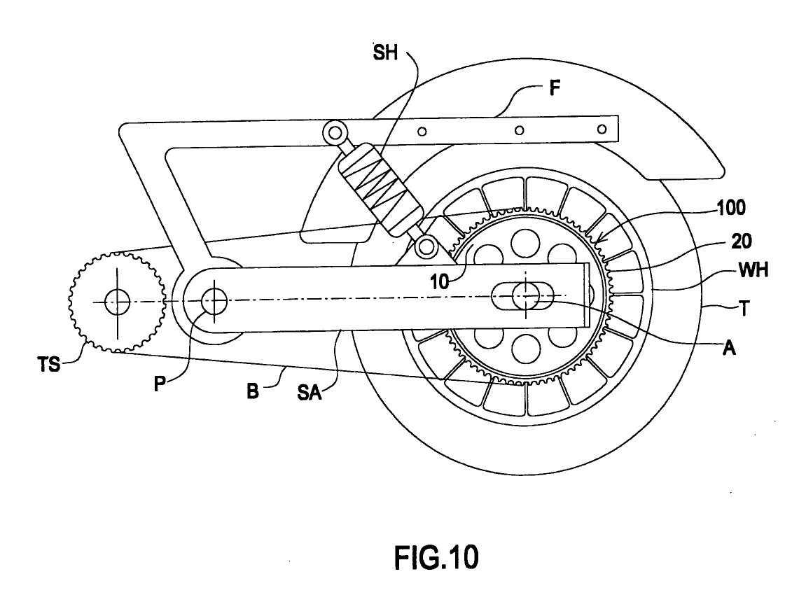

FIG. 10 is a side view of the inventive sprocket in a motorcycle secondary drive and suspension. A known suspension comprises a swingarm SA connected to frame member F at a pivot P. A shock absorber SH is connected between frame F and swingarm SA to suspend the frame and absorb and damp impulses transmitted from the road surface. A transmission sprocket TS, connected to a transmission output shaft known in the art (not shown), is engaged to an inventive sprocket 100 on a rear wheel WH and tire T with an endless member B. Rear wheel WH is journaled to swingarm SA at axle A. Endless member B comprises a toothed belt. Composite sprocket 100 is as described herein. A distinct benefit of the inventive sprocket in this system is that when ring 20 wears from use, it can be easily and inexpensively changed. However, only the wear ring 20 need be replaced. The rim and hub portion of the sprocket need not be replaced. On the other hand, once worn from use it is necessary to replace an entire prior art metal sprocket.

Although forms of the invention has been described herein, it will be obvious to those skilled in the art that variations may be made in the construction and relation of the parts without departing from the spirit and scope of the invention described herein.

1. A sprocket comprising:
a hub having a transverse groove on an outer surface;
a ring engaged with the hub outer surface;
a retaining member engaged with the hub for retaining the ring on the hub outer surfacec; and
the ring having a profile and having a lug on an inner surface for cooperatively engaging the groove.

2. The sprocket as in claim 1, wherein the hub further comprises a circumferential groove for receiving the retaining member.

3. The sprocket as in claim 1, wherein the retaining member comprises a retaining ring.

4. The sprocket as in claim 1, wherein the ring profile comprises a toothed profile.

5. A sprocket comprising:
a hub;
a ring engaged with the hub, the ring having a profile on an outer surface and having a lug projecting radially inward and extending transversely on an inner surface;
the hub comprising a groove for cooperatively engaging the lug;
a retaining member engaged with the hub for holding the ring on the hub; and
the ring comprises polyurethane.

6. The sprocket as in claim 5, wherein the profile comprises teeth.

7. The sprocket as in claim 5 attached to a motorcycle wheel.

8. The sprocket as in claim 5, wherein the retaining member comprises a retaining ring.

9. The sprocket as in claim 8, wherein the hub further comprises a circumferential groove for receiving the retaining ring.

10. A sprocket comprising:
a hub having a transverse groove on an outer surface;
a ring engaged with the hub;
the ring having a profile on an outer surface and having a lug on an inner surface, the lug cooperatively engaging the groove; and
a first and second retaining member engaged with the hub on either side of the ring for retaining the ring on the hub outer surface.

11. The sprocket as in claim 10, wherein the hub further comprises a first and second circumferential groove disposed on each side of the ring for receiving the first and second retaining member.

12. The sprocket as in claim 11, wherein each retaining member comprises a retaining ring.

13. The sprocket as in claim 10, wherein the ring comprises a toothed profile.

14. The sprocket as in claim 10 wherein each retaining member comprises a shoulder having a radius (ID3) greater than a ring radius (ID1).

15. The sprocket as in claim 10 wherein the ring comprises polyurethane, polyamide, polystyrene, polyethylene, or a combination of two or more of the foregoing.

16. A motorcycle suspension system comprising:
a first sprocket comprising:
a hub having a transverse groove on an outer surface;
a ring engaged with the hub, the ring having a surface for engaging a belt;
a retaining member engaged with the hub for retaining the ring on the hub;
the ring having a profile and having a lug on an inner surface for cooperatively engaging the groove;
the sprocket connected to a wheel;
the ring comprising a polymeric material;
a frame member;
a swingarm pivotally connected to the frame member at a pivot;
the wheel journaled to the swingarm;
a shock absorbing member connected between the swingarm and the frame;
a second sprocket cooperatively disposed with the first sprocket;
an endless member entrained between the first sprocket and the second sprocket.

17. The first sprocket as in claim 16, wherein the hub further comprises a circumferential groove for receiving the retaining member.

18. The first sprocket as in claim 16, wherein the retaining member comprises a retaining ring.

19. The first sprocket as in claim 16, wherein the ring comprises a toothed profile.

20. A sprocket comprising:
a hub;
a ring engaged with the hub with an adhesive, the ring having a profile on an outer surface for engaging a belt and having a lug projecting radially and extending transversely on a ring inner surface, the ring having an inside diameter less than a hub outside diameter;
the hub comprising a groove for cooperatively engaging the lug; and
the ring comprises polyurethane.

21. A sprocket comprising:
a hub having a transverse groove on an outer surface;
a polymeric ring cast in place on the hub outer surface; and
the ring having an outer profile.

22. The sprocket as in claim 21, wherein the ring outer profile comprises a toothed profile for engaging a belt.
